(19) United States
(12) Patent Application Publication
(10) Pub. No.: US 2007/0031058 A1
(43) Pub. Date: Feb. 8, 2007

(54) Method and system for blind reconstruction of multi-frame image data

(75) Inventors: Dimitrios Hatzinakos, Scarborough (CA); Stergios Stergiopoulos, Toronto (CA)

Correspondence Address: FREEDMAN & ASSOCIATES, 117 CENTREPOINTE DRIVE, SUITE 350, NEPEAN, ONTARIO, K2G 5X3, CA

(73) Assignee: Canamet Canadian National Medical Technologies Inc., Toronto (CA)

(21) Appl. No.: 11/442,992

(22) Filed: May 31, 2006

Related U.S. Application Data
(60) Provisional application No. 60/688,368, filed on Jun. 8, 2005.

(51) Int. Cl. G06K 9/40; G06K 9/36

(52) U.S. Cl. 382/265; 382/276

(57) ABSTRACT

The present invention relates to a method for blind reconstruction of multi-frame image data. Multi-frame image data corresponding to at least two image frames are received. Using a filter function the image data corresponding to each of the at least two image frames are filtered. The filtered image data are then classified producing data indicative of a classified image for each of the at least two image frames. In a following step the filtered image data are fusion-based classified producing data indicative of a classified fused image. By superposing the corresponding data indicative of the classified image with the data indicative of the classified fused image an error function is determined for each of the at least two image frames. Using the error function the filter function for each of the at least two image frames is then updated. This process is repeated until a stopping criterion is met. After stopping the iteration reconstructed image data based on the filtered image data of at least one of the at least two image frames are provided.

This application claims benefit from U.S. Provisional Patent Application No. 60/688,368 filed Jun. 8, 2005 the entire contents of which are incorporated herein by reference.

### FIELD OF THE INVENTION

This invention relates to image reconstruction and in particular to a method and system for blind reconstruction of high resolution image data from multiple lower resolution and/or distorted image data.

### BACKGROUND OF THE INVENTION

Digital image reconstruction has received considerable attention in the field of image processing and computer vision and has been employed in numerous applications such as astronomical imaging, magnetic resonance imaging, computer tomography, ultrasound imaging, to name a few.

The problem of image reconstruction with known blur functions has been well studied in the past. Inverse filtering and regularized least squares are two of the most popular approaches for this problem.

Unfortunately, in most practical applications the blur functions are usually unknown. When an image reconstruction process relies only on acquired distorted image data without any knowledge - or partial knowledge in some cases - of the distorting parameters the image reconstruction process is termed “blind”.

Image reconstruction processes for blind reconstruction of single frame images have been disclosed in D. Kundur and D. Hatzinakos: “Blind Image Deconvolution”, IEEE Signal Processing Magazine, Vol. 13, No.3, 43-64, 1996, and in D. Kundur, D. Hatzinakos and H. Leung: “Robust Classification ofBlurry Imagery”, IEEE Transactions on Image Processing, Vol. 09, No.2, 243-255, 2000.

However, existing image reconstruction processes for reconstruction of high quality, high resolution images from multiple images having lower resolution and/or are distorted rely on a priori knowledge or partial estimation of the distorting parameters prior to the reconstruction process. One such reconstruction process is disclosed in M. Elad and A.Feuer: “Restoration of a single super-resolution image from several blurred, noisy, and under-sampled measured images”, IEEE Trans. On Image Processing, Vol. 6(12), pp.1646-1658, 1997.

It would be advantageous to satisfy the need for a truly blind image reconstruction process for reconstructing high quality, high resolution images from multiple images having lower resolution and/or are distorted without relying on any a priori knowledge or partial estimation of the distorting parameters. Such a process would, for example, allow in Magnetic Resonance Imaging (MRI) to acquire multiple fast scans in order to reduce motion artifacts from physiological movement, with each fast scan being distorted to some extent by blurring, low contrast and noise artifacts. Application of such an image reconstruction process would then provide high quality, high resolution images from the multiple fast scans.

### SUMMARY OF THE INVENTION

It is, therefore, an object of the invention to provide a method and system for blind reconstruction of image data from multi-frame image data that have lower resolution and/or are distorted.

In accordance with the present invention there is provided a method for blind reconstruction of multi-frame image data comprising:

a) receiving the multi-frame image data, the multi-frame image data corresponding to at least two image frames, the image data of each of the at least two image frames being indicative of a substantially same view of a characteristic of an object;

b) using a filter function filtering the image data corresponding to each of the at least two image frames;

c) classifying the filtered image data corresponding to each of the at least two image frames producing data indicative of a classified image for each of the at least two image frames;

d) fusion-based classifying the filtered image data of the at least two image frames producing data indicative of a classified fused image;

e) determining for each of the at least two image frames an error function by superposing the corresponding data indicative of the classified image with the data indicative of the classified fused image;

f) until a stopping criterion is met, updating the filter function for each of the at least two image frames based on the corresponding error function and repeating b) to f); and,

g) determining reconstructed image data based on the filtered image data of at least one of the at least two image frames.

In accordance with the present invention there is further provided a storage medium having stored therein executable commands for execution on at least a processor, the at least a processor when executing the commands performing:

a) receiving the multi-frame image data, the multi-frame image data corresponding to at least two image frames, the image data of each of the at least two image frames being indicative of a substantially same view of a characteristic of an object;

b) using a filter function filtering the image data corresponding to each of the at least two image frames;

c) classifying the filtered image data corresponding to each of the at least two image frames producing data indicative of a classified image for each of the at least two image frames;

d) fusion-based classifying the filtered image data of the at least two image frames producing data indicative of a classified fused image;

e) determining for each of the at least two image frames an error function by superposing the corresponding data indicative of the classified image with the data indicative of the classified fused image;

f) until a stopping criterion is met, updating the filter function for each of the at least two image frames based on the corresponding error function and repeating b) to f); and,

g) determining reconstructed image data based on the filtered image data of at least one of the at least two image frames.

In accordance with the present invention there is yet further provided a system for blind reconstruction of multi-frame image data comprising:

an input port for receiving the multi-frame image data;

at least a processor in communication with the first port for:

a) receiving the multi-frame image data, the multi-frame image data corresponding to at least two image frames, the image data of each of the at least two image frames being indicative of a substantially same view of a characteristic of an object;

b) using a filter function filtering the image data corresponding to each of the at least two image frames;

c) classifying the filtered image data corresponding to each of the at least two image frames producing data indicative of a classified image for each of the at least two image frames;

d) fusion-based classifying the filtered image data of the at least two image frames producing data indicative of a classified fused image;

e) determining for each of the at least two image frames an error function by superposing the corresponding data indicative of the classified image with the data indicative of the classified fused image;

f) updating the filter function for each of the at least two image frames based on the corresponding error function;

f) until a stopping criterion is met, updating the filter function for each of the at least two image frames based on the corresponding error function and repeating b) to f); and,

g) determining reconstructed image data based on the filtered image data of at least one of the at least two image frames; and,

an output port in communication with the at least a processor for providing the reconstructed image data.

In accordance with an aspect of the present invention there is provided a method for blind reconstruction of multiple data sets comprising:

a) receiving the multiple data sets, the data of each data set being indicative of a substantially same view of a characteristic of an object;

b) using a filter function filtering the data corresponding to each of at least two of the data sets;

c) classifying the filtered data corresponding to each of the at least two data sets producing classification data for each of the at least two data sets;

d) fusion-based classifying the filtered data of the at least two data sets producing fusion-based classification data;

e) determining for each of the at least two data sets an error function by superposing the corresponding classification data with the fusion-based classification data;

f) until a stopping criterion is met, updating the filter function for each of the at least two data sets based on the corresponding error function and repeating b) to f); and,

g) determining reconstructed data based on the filtered data of at least one of the at least two data sets.

### BRIEF DESCRIPTION OF THE FIGURES

Exemplary embodiments of the invention will now be described in conjunction with the following drawings, in which:

FIG. 1 is a flow diagram of a method for blind reconstruction of multi-frame image data according to the invention;

FIG. 2 is a simplified block diagram illustrating a system for blind reconstruction of multi-frame image data according to the invention;

FIG. 3 is a diagram illustrating original and reconstructed cardiac CT images using the method for blind reconstruction of multi-frame image data according to the invention;

FIG. 4 is a diagram illustrating illumination of a standard ultrasound phantom with an adaptive ultrasound beamformer; and,

FIG. 5 is a diagram illustrating original and reconstructed ultrasound images using the method for blind reconstruction of multi-frame image data according to the invention.

### DETAILED DESCRIPTION OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

In the following, the description of the method and system for blind reconstruction of multi-frame image data according to the invention is limited to the processing of multi-frame 2D image data for the sake of simplicity and clarity. However, it will become apparent to those in the art that the method and system for blind reconstruction of multi-frame image data is not limited thereto, but is expandable for blind reconstruction of multi-frame data in 1D—such as time series signal data—as well as of data in dependence upon more than two dimensions—such as a 3D data cube—in a straightforward fashion.

In most applications, data of each acquired image frame are subject to different distortion and noise. For the following description it is assumed, without loss of generality, that M2D image frames rᵢ(x, y) of size [N₁×Nᵢ], with i=1, 2, . . . , M, have been acquired. A distortion image model is then given as:
rᵢ(x,y)=bᵢ(x,y) * fᵢ(x,y)+nᵢ(x,y) (1)
where * denotes two dimensional linear convolution, fᵢ(x, y) is a true image frame, bᵢ(x, y) is a distorting Point Spread Function (PSF), nᵢ(x, y) describes an additive zero mean background noise, and i indicates the i-th acquired image frame. The PSF and the noise are assumed to be different and statistically independent between different image frames. It is further assumed that:
fᵢ(x,y)= . . . =f_{M}(x, y)=f(x, y), or f₁(x,y)≈f₂(x, y)≈ . . . ≈f_{M}(x,y), (2)
i.e. the acquired image frames are distorted versions of either a same scene or slightly different scenes, therefore, providing useful complementary information.

The above assumptions are met during image data acquisition in numerous applications. For example, in brain or cardiac MRI and CT scan imaging multiple scans of a same area in a same 2D plane are obtained at different time instances in order to reconstruct high quality, high resolution images of the scanned area. Due to organ and/or patient motion and dependent on data acquisition parameters such as scan time and scan intervals the scans are subject to different motion and noise artifacts that meet the above assumptions.

In phased array ultrasound imaging, the result of a beamformer is a beam map, which is in polar form written as r(ρ·cosθ, ρ·sin θ) for a discrete value dependent on radius ρε{ρₖ|k=1, . . . , N_{ρ}and angle θε{θₖ|k=1, . . . , N_{θ}}. For simplicity of the implementation the data acquisition is performed using polar coordinates and the beam map is then transformed into Cartesian coordinates r(x,y), x=1, . . . , N, y=1, . . . , N using spatial interpolation. Here, the distortion comprises two superimposed parts. The first part results from beamforming, which is a linear convolution effect and an additive noise interference as described in equation (1). The second part results from nonlinear distortion of the spatial interpolation during coordinate transformation. The resolution of the beamformer is characterized by the azimuth resolution and the radius resolution, with the azimuth resolution being determined by aperture size and beamforming technique—including weighting using a proper window function—and the radius resolution being determined by a length of the ultrasound pulses.

There are numerous ways of obtaining multiple different, yet complementary image frames in phased array beamforming. First, multiple scans of a same area at different time instances are different due to the randomness of the additive background noise and possibly motion artifacts. Second, applying different interpolation schemes results in different nonlinear distortions. Finally, the linear distortion of the beam map depends on each sampling parameter (ρ, θ). Therefore, the process to obtain multiple different, yet complementary image frames from one acquisition is straightforward. For example, a first image frame is obtained as rᵢ(ρ·cos·θ, ρ·sin·θ) for a discrete angle set θε{θ_{1,k}|k=1, . . . , N_{θ}} and other frames are obtained as rᵢ(ρ·cos·θ, ρ·sin·θ) for a discrete angle set θε{θ_{i,k}|k=1, . . . , N_{θ}}, where {θ_{i,k}=θ_{i,k}+i·Δθ|k=1, . . . , N_{θ}} and Δθ is a constant. Furthermore, choice of different weighting windows also results in multiple image frames with different resolution and energy dispersion effects.

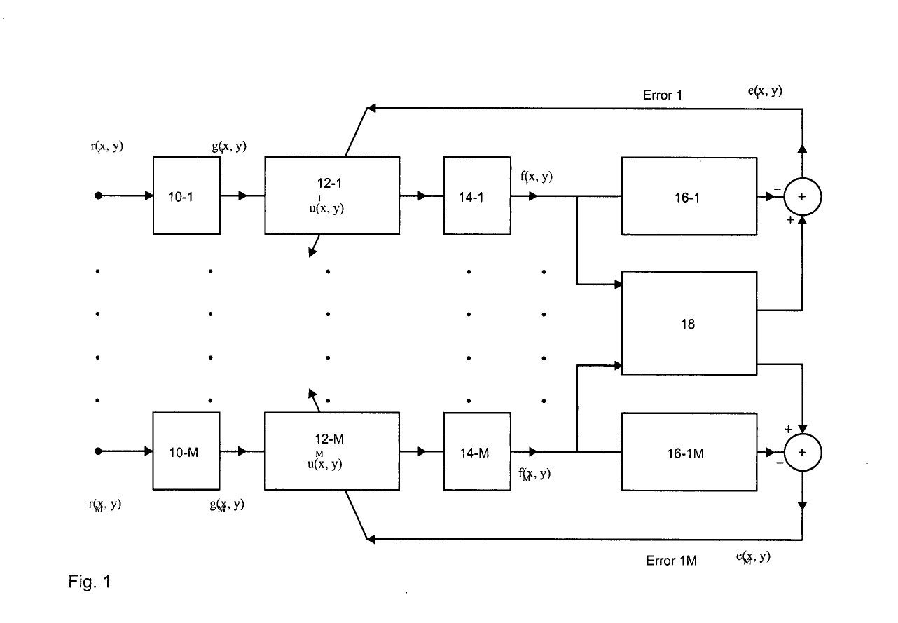

Referring to FIG. 1, a flow diagram of the method for blind reconstruction of multi-frame image data according to the invention is shown. The method comprises as basic processing stages: interpolation—blocks 10(1) to 10(M); recursive filtering—blocks 12(1) to 12(M); post-processing—blocks 14(1) to 14(M); classification—blocks 16(1) to 16(M); and fusion based classification—block 18. The processing stages 10(i) to 16(i), with i=1, 2, . . . , M, are performed individually for each image frame rᵢ(x, y) while processing stage 18 provides the link between the various image frames.

In a first processing stage—blocks 10(i)—low resolution image data of the image frames rᵢ(x, y) are interpolated to a same predetermined higher resolution. As is evident to those skilled in the art, there are numerous interpolation procedures applicable, for example cubic spline interpolation, depending on various factors such as contents of the image frames; difference between the low and the high resolution; and processing means available.

The recursive filtering in each of the blocks 12(i) is an iterative process taking into account information from the other image frames via the fusion based classification stage—block 18—after initialization. At iteration k+1, adjustment of coefficients uₖ₊₁ⁱ(x, y) of the recursive filters 12(i), with i=1, 2, . . . , M, is performed using a gradient optimization known as Newton method:
uₖ₊₁ⁱ(x,y)=uₖⁱ(x, y)+D⁻¹∇J(uₖⁱ) (3)
The gradient with respect to each filter coefficient at iteration k is defined as:

$$\begin{matrix}{[ ∇ J ( {u}_{k}^{i} ) ]}^{T} = [ \frac{\partial J ( {u}_{k}^{i} )}{\partial {u}_{k}^{i} ( 1 , 1 )} \frac{\partial J ( {u}_{k}^{i} )}{\partial {u}_{k}^{i} ( 1 , 2 )} Λ \frac{\partial J ( {u}_{k}^{i} )}{\partial {u}_{k}^{i} ( {N}_{xu} , {N}_{yu} )} ] \\ where & ( 4 ) \\ \frac{\partial J ( {u}_{k}^{i} )}{\partial {u}_{k}^{i} ( i , j )} = \{ {\sum }_{∀ ( x , y )}^{} [ Q ( {e}_{k}^{i} ( x , y ) ) {e}_{k}^{i} ( x , y ) ] {g}_{i} ( x - i + 1 , y - j + 1 ) \} & ( 5 )\end{matrix}$$

with gᵢ(x,y), i=1, . . . , M being the image frames prior reconstruction, Q(eₖⁱ(x,y)) being defined as

$$\begin{matrix}Q ( {e}_{k}^{i} ( x , y ) ) = \{ \begin{matrix}1 , & if {e}_{k}^{i} ( x , y ) \neq 0 \\ 0 , & if {e}_{k}^{i} ( x , y ) = 0\end{matrix} \\ with & ( 6 ) \\ {e}_{k}^{i} ( x , y ) = {C}_{k , fusion \text{-} class} ( x , y ) - {C}_{k , class}^{i} ( x , y ) & ( 7 )\end{matrix}$$

where, for given classification levels, eₖⁱ(x,y) describes an error between a classified fused image and individually classified images f_{i,k}(x, y), i=1, . . . , Mat iteration k.

D⁻¹ is a Hessian—second partial derivatives—of J(uₖ). In many applications a modified Newton method is used. The iteration is then defined as:
uₖ₊₁ⁱ(x, y)=uₖⁱ(x, y)+D⁻¹∇J(ρₖⁱ) (8)
where μ is a step size value being given by an experimental constant or being directly selected by using a line search algorithm along a “Newton direction”. However, the calculation of D⁻¹ requires substantial computational processing when the function J(uₖ) is complicated and/or the number of components of uₖ is large. In order to reduce the computational processing a “quasi-Newton” method having similar convergence properties is employed. Accordingly, equation (8) is represented as follows with Hₖ denoting an approximation of D⁻¹:
uₖ₊₁(x, y)=uₖ(x, y)−μHₖ∇J(uₖ) (9)
with Hₖ being constructed using, for example, a Davidon-Fletcher-Powell process, where at iteration k:
Sₖ=uₖ₊₁−uₖ (10)
Hₖ=(∇J(uₖ₊₁))^{T}−(∇J(uₖ))^{T} ( 11)
As an initial approximation—H₀—is taken to be unit identity matrix I.

Selection of a good stopping criterion for the recursive filtering process enables optimization of the image reconstruction. Due to the recursive filtering in the present method noise and artifact amplification such as ringing is introduced affecting both the quality of the results as well as the classification process during the course of the iteration process. Since each image frame is subject to different distortion, the stopping criterion is applied individually to the iterative processing of each image frame. While the image reconstruction process is stopped for one or more image frames it continues for the rest of the image frames until all image frames have been sufficiently reconstructed. Employment of the error determined using equation (6) is based on strong blind convergence properties of a finite support constraint, where it is assumed that the original image is of finite support against a uniform background and blind image deconvolution is achieved by penalizing image data values outside the finite support. Thus, assuming two classification levels—L=2—are used with finite support images, the error definition of equation (6) is equivalent to the application of the finite support constraint, i.e. the two level classification of the fused image is equivalent to determining the support of the original image and, therefore, the difference between the classified fused image—block 18—and individually classified images—blocks 16(i)—form an error equivalent to the finite support constraint. The recursive filtering according to the invention has several advantages over existing support determination processes:

i) it allows automatic determination of arbitrarily shaped finite support images;

ii) it is applicable to non-finite support images as well with the dispersive effect of blurring being viewed as a support “leaking” effect;

iii) it recursively refines an estimated image support as individual image quality improves; and,

iv) it takes into account not only blurring but other image distortion such as, for example, noise as well.

It is noted that the finite support constraint corresponds to the minimization of a convex cost function. Thus, under ideal conditions global convergence is achieved. In real multi-frame applications, however, local convergence of the process is experienced.

In blocks 14(i) post-processing is individually applied to each image frame. The post-processing includes image scaling and conditioning operations for the following stages of fusion and classification. This involves limiting the data values of each image frame between, for example, 0 and 255, and adjustment of the image mean and energy. Further, in case of major misalignment the post-processing involves registration of the images. It is noted, that small to moderate shifts among image frames are corrected by the recursive process itself.

The classification in blocks 16(i) comprises basically assigning a label to each of the data values corresponding to a pixel in the individual image frames. It has been found that a Markov Random Field (MRF) based classification process provides good results, but as is evident the method for blind reconstruction of multi-frame image data according to the invention is not limited thereto. In the MRF based classification process classifications in the image frames are determined by maximizing an a-posterior (MAP) distribution of a likelihood function, which is based on a Gaussian observational model. This is equivalent to the minimization of the following energy function:

$$\begin{matrix}U ( {f}_{i} ( x , y ) , C ( x , y ) ) = {U}_{obs} ( {f}_{i} ( x , y ) , C ( x , y ) ) - {U}_{prior} ( C ( x , y ) ) \\ where & ( 12 ) \\ {U}_{obs} ( {f}_{i} ( x , y ) , C ( x , y ) ) = \frac{1}{2} ln {σ}_{C ( x , y )}^{2} + \frac{1}{2 {σ}_{C ( x , y )}^{2}} {( {f}_{i} ( x , y ) - {μ}_{C ( x , y )} )}^{2} \\ and & ( 13 ) \\ {U}_{prior} ( C ( x , y ) ) = β n ( C ( x , y ) ) & ( 14 )\end{matrix}$$

with C(x,y)=1,2, . . . , L being an index of L classes and n(C(x,y)) being the number of neighbors of the pixel located at (x,y) that are equal to the class level C(x,y). β is a user-specified nonnegative scalar parameter that controls a degree of spatial contextual information. σ_{c(x,y)}² and μ_{c(x,y)} are variance and mean of class C(x,y), respectively, which are either defined or estimated prior to classification. This is accomplished, for example, by applying a K-means clustering process where the following square distance is minimized:

$${\sum }_{x , y}^{} {‖ {f}_{i} ( x , y ) - {μ}_{C ( x , y )} ‖}^{2} \qquad ( 15 )$$

with C(x,y) being the index of the class level, out of L class levels, closest to fᵢ(x, y).

The fusion-based classification—block 18—is based on the assumption that image frames from different sources are registered and have a same spatial resolution. For a pixel located at (x,y), a MAP classification estimate is obtained by minimizing the following energy function:

$$U ( {f}_{1} , {f}_{2} , … , {f}_{M} , C ) = {\sum }_{s = 1}^{M} {U}_{obs} ( {f}_{i} , C ) + {U}_{prior} ( C ) \qquad ( 16 )$$

where U_{obs} (fᵢ, C) and Uₚᵣᵢₒᵣ (fᵢ, C) are given by equations (7) and (8), respectively, fᵢ, i=1,2, . . . M, are the image frames to be fused, and C is the classification image. The fusion-based classification process becomes a classification process when only one image frame is considered.

It is noted that the fusion-based classification does not provide a fused image but only a classification based on fusing the individual image frames. If a single fused image is desired, a classical technique such as averaging or minimum variance fusion is applied. However, in many applications such as medical imaging even small differences between the reconstructed image frames are important and therefore, it is desired to observe the individual reconstructed image frames.

After the above explanation of the various processing stages of the method for blind reconstruction of multi-frame image data according to the invention, a data processing flow will now be described with reference to flow diagram illustrated in FIG. 1. After provision of data indicative of M image frames rᵢ(x, y) of size [Nᵢ×Nᵢ], with i=1, 2, . . . , M, high resolution images gᵢ(x, y), i=1, . . . , M of same size N×N are interpolated—blocks 10-I to 10-M. The interpolation is performed separately for each received image frame rᵢ (x, y). As is evident, it is possible to interpolate M image frames rᵢ(x, y) of different size, i.e. of different resolution, to M image frames gᵢ(x, y) of a same size. Furthermore, the size [Nᵢ×Nᵢ] of the image frames rᵢ(x, y) has been chosen for simplicity but is not limited thereto.

In preparation of the following recursive filtering process—blocks 12-1 to 12-M—the size Q×Q of the recursive filters uₖⁱ(x, y) is chosen, and the initial recursive filters u₀ⁱ(x, y) are determined by placing 1 in the center and 0 elsewhere. Further, the step size value μ is chosen as well as the number of classification levels L. Finally, a stopping criterion is determined for stopping the recursive filtering after a number of iterations K. For example, the stopping criterion is determined by providing a threshold value for the error between a classified fused image and individually classified images—equation (6)—at iteration K. The above parameters are provided by a user, for example, via a graphical user interface allowing the user to incorporate his or her experience into the image reconstruction process. Alternatively, default values found to be a good fit for a large variety of different types of image frames are already incorporated. Further alternatively, default values are given providing guidance but the user is enabled to change at least some of the parameters according to his or her experience.

After the above preparation step the following iterative process is performed for k=1,2, . . . , K:

First, the output data of each of the recursive filters—blocks 12-1 to 12-M—is determined by convolving gᵢ(x,y) * uₖ₋₁ⁱ(x,y), i=1, . . . , M, for each image frame separately;

Second, the output data of the recursive filters are post-processed for fusion and classification—blocks 14-1 to 14-M—for each image frame separately;

Third, the K-means process of relation (15) is applied to f_{1,k}(x, y)—output data of block 14-1—to determine the L classification levels—σ_{c(x,y)}² and μ_{c(x,y)}, C(x,y)=1, . . . , L, alternatively, another image frame i is chosen as reference;

Fourth, class levels C_{k,class}ⁱ(x,y),i=1, . . . . , M are obtained based on equation (12)—blocks 16-1 to 16-M—for each image frame separately, and fusion based class levels C_{k,fusion-class}(x, y) are obtained based on equation (16) by fusing the output data of the blocks 14-1 to 14-M in block 18;

Fifth, the error eₖⁱ(x,y)=C_{k,fusion-class}(x,y)−C_{k,class}ⁱ(x,y), i=1, . . . , M, is determined—equation (6)—for each image frame separately; and,

Sixth, the recursive filters uₖⁱ(x,y) are updated based on equations (4), (5), and (8) for each image frame separately.

When the stopping criterion is met for an image frame i=1, . . . , M, the iterative process is stopped for this image frame and a reconstructed image fᵢ(x,y) i=1, . . . , M is obtained—output data of block 14-i, while the iterative process is continued for the remaining image frames until the stopping criterion is met for all M image frames.

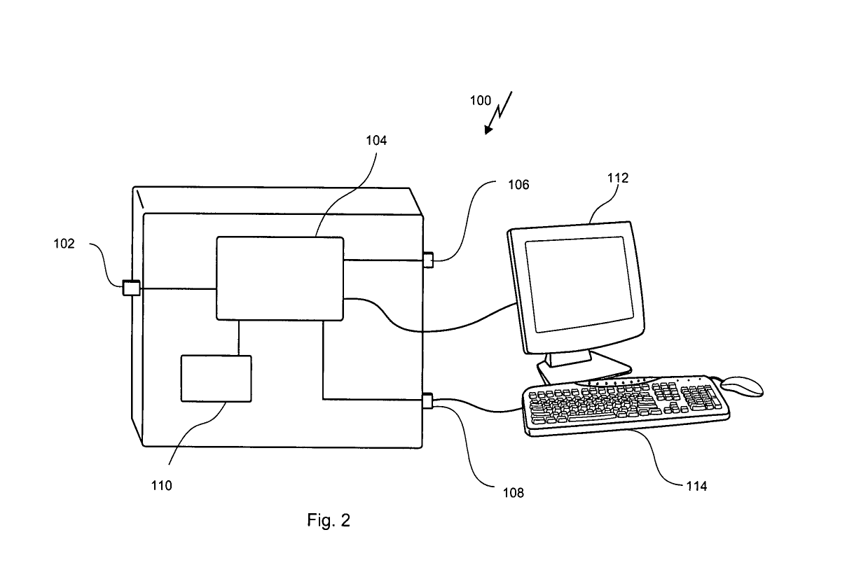

Referring to FIG. 2, a system 100 for blind reconstruction of multi-frame image data according to the invention is shown. The multi-frame image data indicative of M image frames rᵢ(x, y) are received at input port 102. Using electronic circuitry such as a processor 104 the multi-frame image data are then digitally processed as outlined above. The system 100 further comprises a storage medium 110 having stored therein executable commands for execution on the processor 104 for performing the data processing. Alternatively, the processor 104 comprises electronic circuitry designed for performing at least a portion of the data processing in a hardware implemented fashion. The system 100 further comprises an output port 106 for providing the processed signal data for storage or further processing. User interaction such as provision of parameter values for the recursive filter processing is provided, for example, via a graphical representation of at least an image frame rᵢ(x, y) on display 112 and provision of control commands via port 108—connected, for example, to a keyboard 114—to the processor 104. Employment of a graphical user interface for the display 112 facilitates user interaction during data processing. The M image frames rᵢ(x, y) as well as the M reconstructed image frames fᵢ(x, y) are, for example, graphically displayed on the display 112.

Since large portions of the data processing—blocks 10, 12, 14, and 16—are performed for each image frame separately—only during the fusion based classification—block 18—data are exchanged between the M image frames—the method for blind reconstruction of multi-frame image data according to the invention is well suited for parallel processing using, for example, M processors for processing the M image frames in parallel. Using parallel processing is highly advantageous for the blind reconstruction of large 2D images or 3D image data by substantially increasing processing speed.

Furthermore, it is also possible to implement the blind reconstruction of multi-frame image data according to the invention as a retrofit into existing imaging or image processing systems, for example, as executable commands provided on a storage medium for execution on a processor of the existing system. Alternatively, the blind reconstruction of multi-frame image data according to the invention is provided as a hardware module for installation into the existing system.

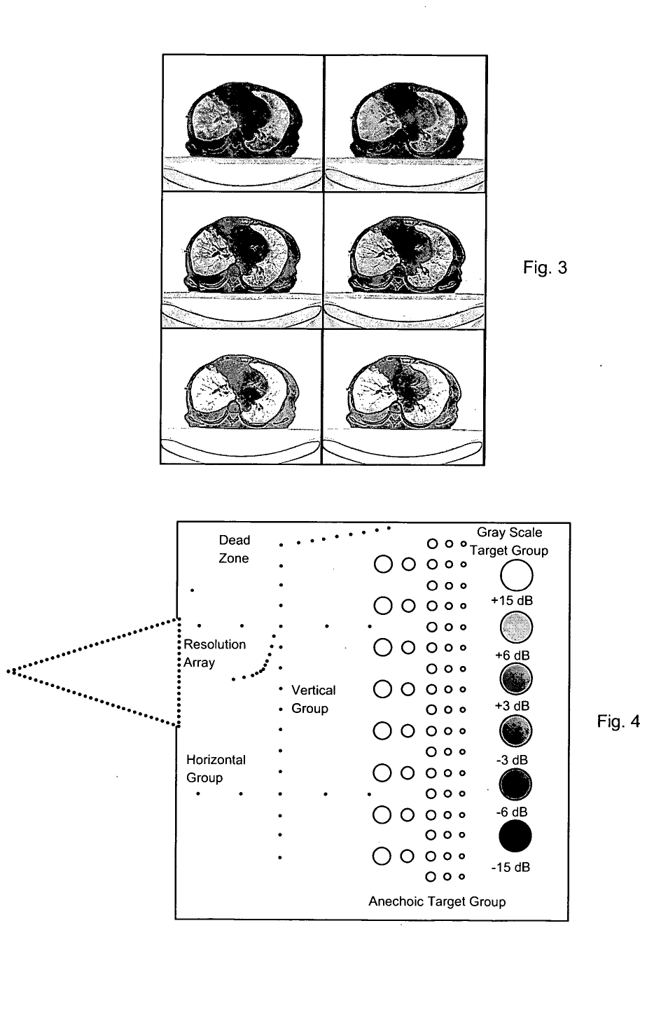

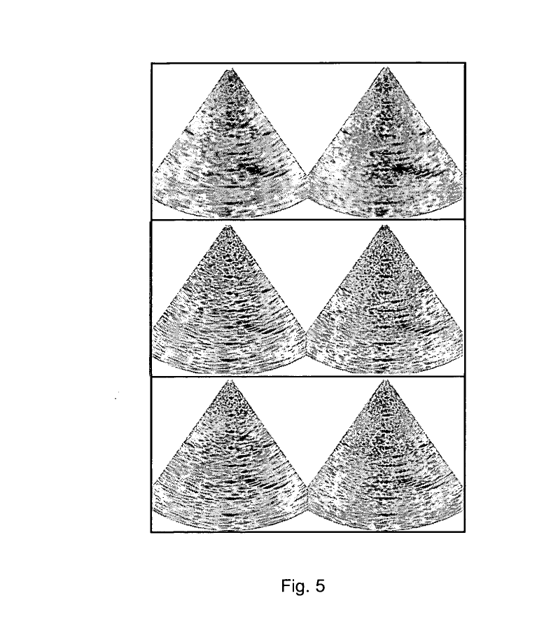

FIGS. 3 and 5 illustrate original images and reconstructed images of computer simulations and real image data in order to demonstrate the effectiveness of the method for blind reconstruction of multi-frame image data according to the invention. For the reconstruction performed recursive filters of size 7×7 pixels with an initial value of 1 in the center and 0 elsewhere have been used, i.e. u₀ⁱ(4,4)=1 and u₀ⁱ(1, m)=0, 1, m≠0, i=1, . . . , M. Without loss of generality, the number of classification levels has been set to L=2. During iteration a constant adjustment step size μ between 0.08 and 0.2 has been used for its simplicity and because it provides a constant convergence rate. At each iteration step image frame one has been chosen as reference image in order to adjust the mean and energy of all reconstructed images prior to fusion and to determine the values of the classification levels. During classification β=4 and 4 neighbor pixels have been used in the processing according to equation (14). Finally, minimization of the energy function—equation (12)—has been performed out using Besag's Iterate Conditional Modes (ICM) process.

To quantitatively compare the degree of improvement of the blind image reconstruction, an objective image quality metric called the Image Quality Measure (IQM) is used. The IQM is derived from the normalized (brightness, image size) and weighted (vision filter, noise filter, directional scale) 2D Power spectrum of the image. The IQM is an automated and objective quality measure based on the invariance properties of the Power spectrum of images.

Results using real cardiac CT images are depicted in FIG. 3. Only image frames 1 and 3 out of 8 image frames used in the reconstruction are illustrated. The original image frames are shown in the top row. Due to heart activity and electric noise the images are blurred and noisy. In the middle row the reconstructed image frames after 12 iterations and in the bottom row contrast adjusted image reconstructed image frames after 12 iterations are shown. Clearly, the reconstructed images are substantially sharper and show more detail. The reconstructed image frames have been contrast adjusted in order to highlight better detected arterial calcification. The substantial improvement in image quality is also clearly visible in the IQM evaluation shown in Table 1.

TABLE 1

Frames

| | Frame 1 | Frame 2 |
|---|---|---|
| Original | 0.0186 | 0.0222 |
| Reconstructed | 0.0282 | 0.0270 |
| Contrast adjusted | 0.0057 | 0.0058 |

Results using a standard ultrasound phantom are depicted in FIG. 5. The phantom has been illuminated with an adaptive ultrasound beamformer developed by CANAMET Inc. The profile of the phantom and the illuminated area are shown in FIG. 4. To create a multi-frame scenario a multi-scanning process of the same phantom area has been applied. One image frame has been obtained by applying a Hann window weighting to the beamformer. The original and reconstructed images are shown in FIG. 5. The left column shows the image frames obtained with the Hann window while the right column shows the image frames obtained with a rectangular window. The original image frames are shown in the top row. In the middle row the reconstructed image frames after 12 iterations and in the bottom row contrast adjusted image reconstructed image frames after 12 iterations are shown. Again, the reconstructed images are substantially sharper and show more detail. The substantial improvement in image quality is also clearly visible in the IQM evaluation shown in Table 2.

TABLE 2

Window

| | Hann | Rectangular |
|---|---|---|
| Frames | window | window |
| Original | 0.00076 | 0.00075 |
| Reconstructed | 0.00191 | 0.00177 |
| Contrast adjusted | 0.00208 | 0.00193 |

The method and system for blind reconstruction of multi-frame image data according to the invention is highly advantageous in numerous applications by providing a truly blind image reconstruction process for reconstructing a high quality, high resolution image from multiple images having lower resolution and/or are distorted without relying on any a priori knowledge or partial estimation of the distorting parameters. For example, in MRI imaging multiple fast scans are acquired in order to reduce motion artifacts from physiological movement, with each fast scan being distorted to some extent by blurring, low contrast and noise artifacts. Using the blind reconstruction of multi-frame image data according to the invention, high quality, high resolution images are then reconstructed from the multiple fast scans.

Numerous other embodiments of the invention will be apparent to persons skilled in the art without departing from the spirit and scope of the invention as defined in the appended claims.

What is claimed is:

1. A method for blind reconstruction of multi-frame image data comprising:
a) receiving the multi-frame image data corresponding to at least two image frames, the image data of each of the at least two image frames indicative of a substantially same view of a characteristic of an object;
b) using a filter function filtering the image data corresponding to each of the at least two image frames;
c) classifying the filtered image data corresponding to each of the at least two image frames producing data indicative of a classified image for each of the at least two image frames;
d) fusion-based classifying the filtered image data of the at least two image frames producing data indicative of a classified fused image;
e) determining for each of the at least two image frames an error function by superposing the corresponding data indicative of the classified image with the data indicative of the classified fused image;
f) until a stopping criterion is met, updating the filter function for each of the at least two image frames based on the corresponding error function and repeating b) to f); and,
g) determining reconstructed image data based on the filtered image data of at least one of the at least two image frames.

2. A method for blind reconstruction of multi-frame image data as defined in claim 1 wherein the multi-frame image data comprise one of 2 dimensional and 3 dimensional image data.

3. A method for blind reconstruction of multi-frame image data as defined in claim 2 wherein g) comprises fusing the filtered image data of at least one of the at least two image frames.

4. A method for blind reconstruction of multi-frame image data as defined in claim 2 wherein f) is performed individually for each of the at least two image frames.

5. A method for blind reconstruction of multi-frame image data as defined in claim 4 wherein the stopping criterion is based on a predetermined threshold value of the error function.

6. A method for blind reconstruction of multi-frame image data as defined in claim 2 comprising:
a1) processing the multi-frame image data corresponding to the at least two image frames to produce multi-frame image data having a predetermined same resolution.

7. A method for blind reconstruction of multi-frame image data as defined in claim 2 comprising:
b1) post-processing the filtered image data corresponding to each of the at least two image frames.

8. A method for blind reconstruction of multi-frame image data as defined in claim 7 wherein b1) comprises one of image scaling, image conditioning, and image registration.

9. A method for blind reconstruction of multi-frame image data as defined in claim 5 wherein f) a quasi-Newton process is used for updating the filter function.

10. A method for blind reconstruction of multi-frame image data as defined in claim 9 wherein at least one of c) and d) a Markov Random Field based classification process is used.

11. A method for blind reconstruction of multi-frame image data as defined in claim 2 wherein the multi-frame image data are captured in a single acquisition.

12. A method for blind reconstruction of multi-frame image data as defined in claim 11 wherein the multi-frame image data are produced using a beamforming process and varying at least one of interpolation process, azimuth angle, radius, and weighting window.

13. A storage medium having stored therein executable commands for execution on at least a processor, the at least a processor when executing the commands performing:
a) receiving the multi-frame image data, the multi-frame image data corresponding to at least two image frames, the image data of each of the at least two image frames being indicative of a substantially same view of a characteristic of an object;
b) using a filter function filtering the image data corresponding to each of the at least two image frames;
c) classifying the filtered image data corresponding to each of the at least two image frames producing data indicative of a classified image for each of the at least two image frames;
d) fusion-based classifying the filtered image data of the at least two image frames producing data indicative of a classified fused image;
e) determining for each of the at least two image frames an error function by superposing the corresponding data indicative of the classified image with the data indicative of the classified fused image;
f) until a stopping criterion is met, updating the filter function for each of the at least two image frames based on the corresponding error function and repeating b) to f); and,
g) determining reconstructed image data based on the filtered image data of at least one of the at least two image frames.

14. A system for blind reconstruction of multi-frame image data comprising:
an input port for receiving the multi-frame image data;
at least a processor in communication with the first port for:
a) receiving the multi-frame image data, the multi-frame image data corresponding to at least two image frames, the image data of each of the at least two image frames being indicative of a substantially same view of a characteristic of an object;
b) using a filter function filtering the image data corresponding to each of the at least two image frames;
c) classifying the filtered image data corresponding to each of the at least two image frames producing data indicative of a classified image for each of the at least two image frames;
d) fusion-based classifying the filtered image data of the at least two image frames producing data indicative of a classified fused image;
e) determining for each of the at least two image frames an error function by superposing the corresponding data indicative of the classified image with the data indicative of the classified fused image;
f) until a stopping criterion is met, updating the filter function for each of the at least two image frames based on the corresponding error function and repeating b) to f); and,
g) determining reconstructed image data based on the filtered image data of at least one of the at least two image frames; and,
an output port in communication with the at least a processor for providing the reconstructed image data.

15. A system for blind reconstruction of multi-frame image data as defined in claim 14 wherein the at least a processor comprises electronic circuitry designed for performing at least a portion of a) to h).

16. A system for blind reconstruction of multi-frame image data as defined in claim 14 comprising a control port in communication with the at least a processor for receiving control commands for controlling at least one of filtering the image data, classifying the filtered image data, fusion-based classifying the filtered image data, and the stopping criterion.

17. A system for blind reconstruction of multi-frame image data as defined in claim 16 comprising a graphical display in communication with the at least a processor for displaying image data in a graphical fashion.

18. A system for blind reconstruction of multi-frame image data as defined in claim 17 wherein the graphical display comprises a graphical user interface.

19. A system for blind reconstruction of multi-frame image data as defined in claim 14 comprising at least two processors, each of the at least two processors for processing data corresponding to one of the at least two image frames.

20. A method for blind reconstruction of multiple data sets comprising:
a) receiving the multiple data sets, the data of each data set being indicative of a substantially same view of a characteristic of an object;
b) using a filter function filtering the data corresponding to each of at least two of the data sets;
c) classifying the filtered data corresponding to each of the at least two data sets producing classification data for each of the at least two data sets;
d) fusion-based classifying the filtered data of the at least two data sets producing fusion-based classification data;
e) determining for each of the at least two data sets an error function by superposing the corresponding classification data with the fusion-based classification data;
f) until a stopping criterion is met, updating the filter function for each of the at least two data sets based on the corresponding error function and repeating b) to f); and,
g) determining reconstructed data based on the filtered data of at least one of the at least two data sets.
